(19) United States
(12) Patent Application Publication
(10) Pub. No.: US 2020/0302486 A1
(43) Pub. Date: Sep. 24, 2020

(54) METHOD AND SYSTEM FOR DETERMINING OPTIMIZED CUSTOMER TOUCHPOINTS

(71) Applicant: RUBIKLOUD TECHNOLOGIES INC.

(72) Inventors: Waleed AYOUB, Toronto (CA); Brian KENG, Toronto (CA)

(21) Appl. No.: 16/089,053

(22) PCT Filed: Mar. 28, 2017
(86) PCT No.: PCT/CA2017/050383

§ 371 Date: Sep. 27, 2018

(51) Int. Cl. G06Q 30/02; G06N 20/00

(52) U.S. Cl. CPC G06Q 30/0276; G06Q 30/0271; G06Q 30/0247; G06N 20/00

(57) ABSTRACT

A method and system for determining optimized customer touchpoints are provided. The method includes assigning attributes to a set of marketing content for a set of customers; generating at least one initial score for the behavior of each of the customers in the set of customers; selecting a first subset of the marketing content for each of a first subset of the customers to receive for a first marketing campaign; receiving feedback data relating to the first subset of the marketing content; determining at least one adjusted score, from the at least one initial score, for at least some of the customers; and selecting a second subset of the marketing content for each of a second subset of the customers to receive based at least partially on the at least one adjusted score.

### TECHNICAL FIELD

The following relates generally to marketing and more specifically to a method and system for determining optimized customer touchpoints.

### BACKGROUND

The generation of a marketing campaign is typically a manual process. In practice, marketing managers that are subject matter experts leverage various marketing automation tools, basic analytic tools, and marketing channels to deploy marketing campaigns to engage their customers. Some examples include a product coupon emailed to a customer, a message sent via SMS with a link to a landing page containing some advertising communication, and the pushing of relevant product or category content through a mobile application. The intent of these tactics is to attract customers to their stores, be those brick and mortar stores or online stores, and ultimately spend money on the goods and services they sell.

In order to create a marketing campaign, a goal is first identified, such as customer retention. Marketing content is generated by the marketing manager to achieve this goal using business intuition. Marketing content can be any offer or information having innate or assigned attributes that enable its matching to specific customers. It can be used to promote the goods and/or services of a company or group of companies. The marketing content can be, for example, an offer of a discount of $2 on the next purchase over $20. Once the marketing content is set, the marketing manager can use a customer relationship management (“CRM”) system to select a set of customers (i.e., a target audience) to send the marketing content to. Marketing content can also be information related or unrelated to products, such as recipes, articles, etc.

CRM systems generally enable the selection of individuals, groups, and segments of a population to receive marketing communications based on various criteria that are specified by a user. The criteria can be specified via a set of filters. Upon setting the filters, the CRM system selects a subset of the customers in a customer database that match the specified criteria. The CRM system then enables the marketing manager to push the marketing content to the subset of the customers. The marketing content is, however, quite static and is generally not very personalized for each customer.

### SUMMARY

In an aspect, there is provided a method for determining optimized customer touchpoints on a computer system, the method comprising: assigning attributes to a set of marketing content for a set of customers; generating at least one initial score for the behavior of each of the customers in the set of customers using machine learning techniques based on the attributes; selecting a first subset of the marketing content for each of a first subset of the customers to receive based at least partially on the at least one initial score; receiving feedback data relating to the first subset of the marketing content; determining at least one adjusted score, from the at least one initial score, for at least some of the customers, using reinforcement learning on the feedback data; and selecting a second subset of the marketing content for each of a second subset of the customers to receive based at least partially on the at least one adjusted score.

In a particular case, the feedback data comprises customer behavioral data of at least a portion of the customers in the first subset of the customers.

In another case, the method further comprising receiving at least a portion of the attributes from a user.

In yet another case, the machine learning techniques utilize at least one of: a predictive response model for determining a probability that a particular customer in the set of customers responds to the marketing content; a predictive uplift model for determining a probability that a particular customer in the set of customers responds to the marketing content, who in the absence of such marketing content, would not have responded; a reactive churn model for determining a change in value over a selected period of time for each customer in the set of customers; and a predictive churn model for determining a change in value over multiple periods of time for each customer in the set of customers.

In yet another case, the at least one initial score is generated using historical interaction data from the set of customers.

In yet another case, the method further comprising assigning weightings to at least a portion of the attributes based on priority of a customer objective.

In yet another case, the reinforcement learning comprises an incremental reward structure.

In a further case, the reward structure is based on increments and decrements in customer sales.

In yet another case, the reinforcement learning comprises a weighted reward structure.

In yet another case, receiving the feedback data, determining the at least one adjusted score, and selecting the second subset of the marketing content are performed repeatedly.

In another aspect, there is provided a system for determining optimized customer touchpoints, the system comprising one or more processors and a data storage device, the one or more processors configured to execute: an attributes module for assigning attributes to a set of marketing content for a set of customers; a data science module for generating at least one initial score for the behavior of each of the customers in the set of customers using machine learning techniques based on the attributes; a selection module for selecting a first subset of the marketing content for each of a first subset of the customers to receive based at least partially on the at least one initial score; and a feedback module for receiving feedback data relating to the first subset of the marketing content, the data science module further determines at least one adjusted score, from the at least one initial score, for at least some of the customers, using reinforcement learning on the feedback data, and the selection module further selects a second subset of the marketing content for each of a second subset of the customers to receive based at least partially on the at least one adjusted score.

In a particular case, the feedback data comprises customer behavioral data of at least a portion of the customers in the first subset of the customers.

In another case, the attributes module receives at least a portion of the attributes from a user via an input interface.

In yet another case, the data science module uses machine learning techniques that utilize at least one of: a predictive response model for determining a probability that a particular customer in the set of customers responds to the marketing content; a predictive uplift model for determining a probability that a particular customer in the set of customers responds to the marketing content, who in the absence of such marketing content, would not have responded; a reactive churn model for determining a change in value over a selected period of time for each customer in the set of customers; and a predictive churn model for determining a change in value over multiple periods of time for each customer in the set of customers.

In yet another case, the at least one initial score is generated by the data science module using historical interaction data from the set of customers.

In yet another case, the attributes module assigns weightings to at least a portion of the attributes based on priority of a customer objective.

In yet another case, the reinforcement learning comprises an incremental reward structure.

In a further case, the reward structure is based on increments and decrements in customer sales.

In yet another case, the reinforcement learning comprises a weighted reward structure.

In yet another case, the feedback module repeatedly receives new feedback data such that the data science module repeatedly adjusts the at least one adjusted score based on the new feedback data, and the selection module repeatedly selects the second subset of the marketing content based on the new at least one adjusted score.

These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 shows a system for determining optimized customer touchpoints and its operating environment in accordance with an embodiment;

FIG. 2 is a schematic diagram of the system of FIG. 1;

FIG. 3 illustrates an exemplary screen generated by the system of FIG. 1 for configuring a marketing campaign;

FIG. 4 illustrates another exemplary screen generated by the system of FIG. 1 for configuring a marketing campaign;

FIG. 5 is a chart illustrating the general approach used by the system of FIG. 1 for determining optimized customer touchpoints;

FIG. 6 is a chart showing the cumulative response rate for a predictive response model of the system of FIG. 1;

FIG. 7 is a flow chart of the general method of targeted marketing used by the system of FIG. 1; and

FIG. 8 is a flow chart of a method for determining optimized customer touchpoints used by the system of FIG. 1.

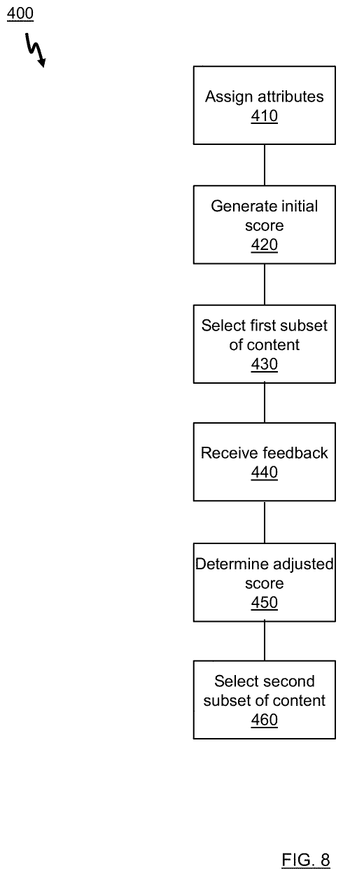

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to marketing and more specifically to a method and a system for determining optimized customer touchpoints. The method and system provides a method by which custom marketing campaigns can be run in an automated manner using customer data.

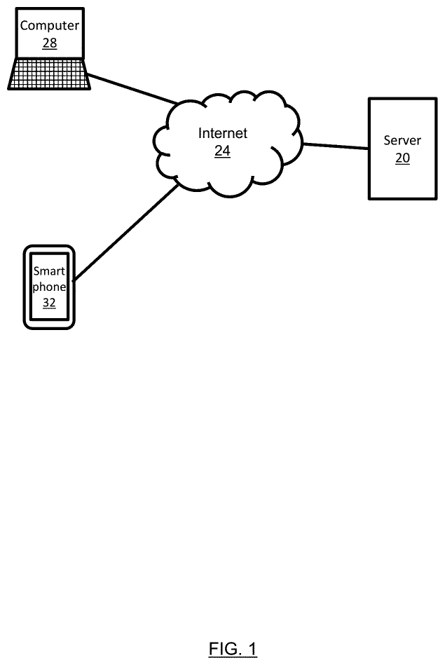

Referring now to FIG. 1, a system 20 for determining optimized customer touchpoints in accordance with an embodiment is shown. The system 20 is in communication with a set of computing devices operated by customers over the Internet 24. The illustrated computing devices in this embodiment include a laptop computer 28 and a smartphone 32. Other computing devices that can be used by customers include, for example, tablet computers, in-store point-of-sale (“PoS”) devices, in-store clienteling devices, smartwatches. The computing devices of the customers are configured to receive marketing content from the system 20 and provide customer interaction data back to the system 20. The system 20 is operated on behalf of a third-party for one or more client companies. Its operation will be discussed with respect to a single client company, but it should be understood that the system 20 can be used to manage the marketing campaigns of two or more companies, or that it can be used by the company performing the marketing.

The system 20 enables the creation of personalized marketing content that is selected for and delivered to a subset of customers, thereby providing them bespoke experiences as a replacement for traditional direct marketing methods. Through the interaction with digitized point-of-sale machines, loyalty programs, digital communication channels, and various other means, a vast amount of customer data is being generated for each customer. The various customer data is collected mainly through PoS terminals, recurring billing (in the case of contractual services), and e-commerce websites of the transactional variety, and through other means such as market research, 3rd party aggregation, and other data resellers and brokers. The system 20 draws upon this customer data from the various channels in order to better understand the behavior of each customer. The system 20 mines this data and applies statistical and machine learning approaches to yield recommendations and actions that enable deeply personalized experiences.

The solution provided by the system 20 is one that is personalized. Traditional CRM systems marketing enable a marketing campaign to be targeted at customers to which it may be relevant. For example, upon the generation of a promotional email regarding certain products, traditional CRM systems enable the selection of which customers the promotion may be relevant to using marketing intuition or other simplified heuristics. Selection of a group of customers to send the promotional email to can be determined by, for example, ranking customers in order of highest spenders, and providing the top 10% of that list a global discount. In contrast, the system 20 customizes marketing campaigns in an automated manner by controlling the timing of delivery, preferred channel of communication, discounting, taking into consideration the customers share of wallet, and a slew of other aspects of the customer experience. In doing so, the system 20 approaches marketing in a holistic, real-time manner.

It uses a combination of constrained optimization, prediction, and reinforcement learning to directly optimize for key financial objectives (e.g., increased customer value over time, incremental sales in a short period, reduced customer churn, etc.). It leverages predictions about customers and other latent behaviors and selects the right mix of marketing content (that is, offers and other content in order to achieve specified business objectives given certain inputs and constraints. Still further, the system 100 simplifies the process by providing an intuitive interface through which to provide the inputs.

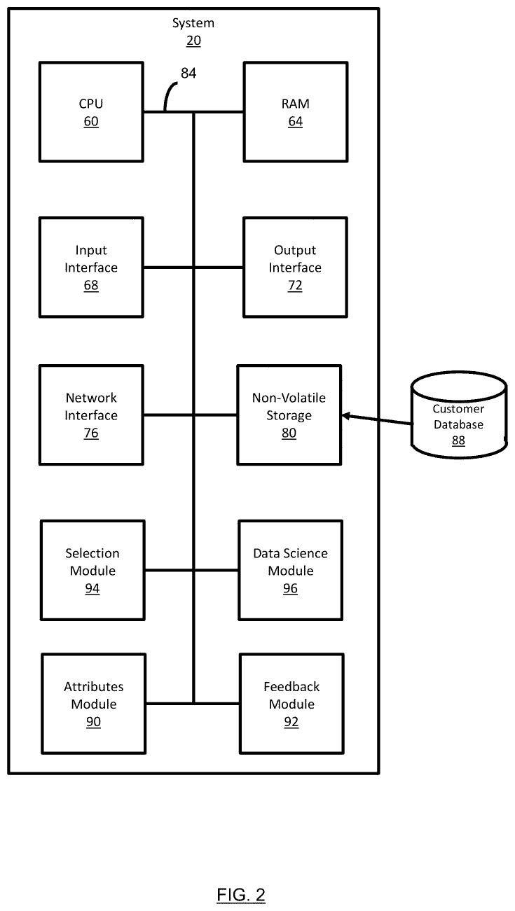

FIG. 2 shows various physical and logical components of the system 20. As shown, the system 20 has a number of physical and logical components, including a central processing unit (“CPU”) 60, random access memory (“RAM”) 64, an input interface 68, an output interface 72, a network interface 76, non-volatile storage 80, and a local bus 84 enabling CPU 60 to communicate with the other components. CPU 60 can include one or more processors. CPU 60 executes an operating system, a web service, an email server, and a marketing platform. The functionality of the marketing platform is described below in greater detail. RAM 64 provides relatively responsive volatile storage to CPU 60. The input interface 68 enables an administrator to provide input via a keyboard and mouse. The output interface 72 outputs information to output devices, such as a display and/or speakers. The network interface 76 permits communication with other systems, such as computing devices 28, 32. Non-volatile storage 80 stores the operating system and programs, including computer-executable instructions for implementing the web server and the marketing platform, as well as any data used by these services. This data includes marketing content that is generated and/or loaded by a marketing manager, and customer data from the various sources that is stored in a customer database 84. During operation of the system 20, the operating system, the programs and the data may be retrieved from the non-volatile storage 80 and placed in RAM 64 to facilitate execution. In an embodiment, the CPU 60 can be configured to execute an attributes module 90, a feedback module 92, a selection module 94, and a data science module 96.

The marketing platform includes a management console accessible via a web interface generated by the web server. The management console enables a marketing manager to define marketing campaigns and view results via a campaign editor, delegate tasks for a campaign to other people, enable notifications such as via email for milestones in the process of defining a campaign, define/upload marketing content, directly integrate the system with marketing automation and execution tools, select a creative template for a campaign based on historical performance of the creative template, etc. During marketing campaign creation, the campaign editor enables the marketing manager to specify the following inputs and constraints:
quantity of customers to be targeted
start date, end date and frequency of communication
strategic focus and the types of customers to be targeted
different templates and creative outputs to expose to the customers
key categories, products or brands that should receive lower or heavier weightings
long term objectives, such as: grow, maintain, win-back

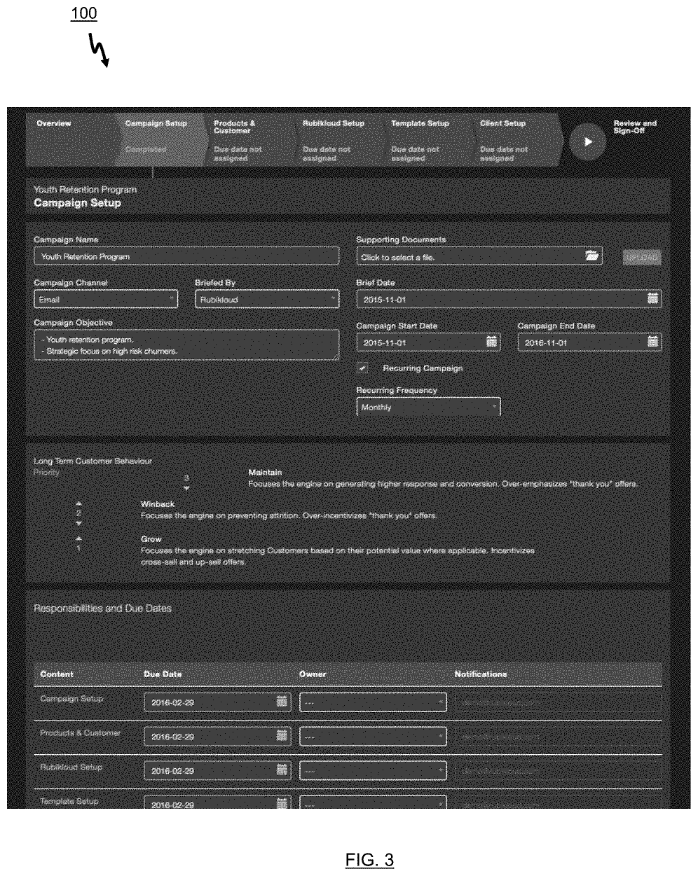

FIG. 3 shows an exemplary screen 100 for defining a campaign presented by the campaign editor. The campaign definition screen 100 enables the following information and attributes to be specified by the attributes module 90:
campaign name
supporting documents
channel (where it is desired to use only a particular channel instead of system-recommended channels)
campaign description
start date
end date
recurring frequency, if any
prioritization of customer retention, customer win-back, and customer business growth
deadlines for setting up the campaign

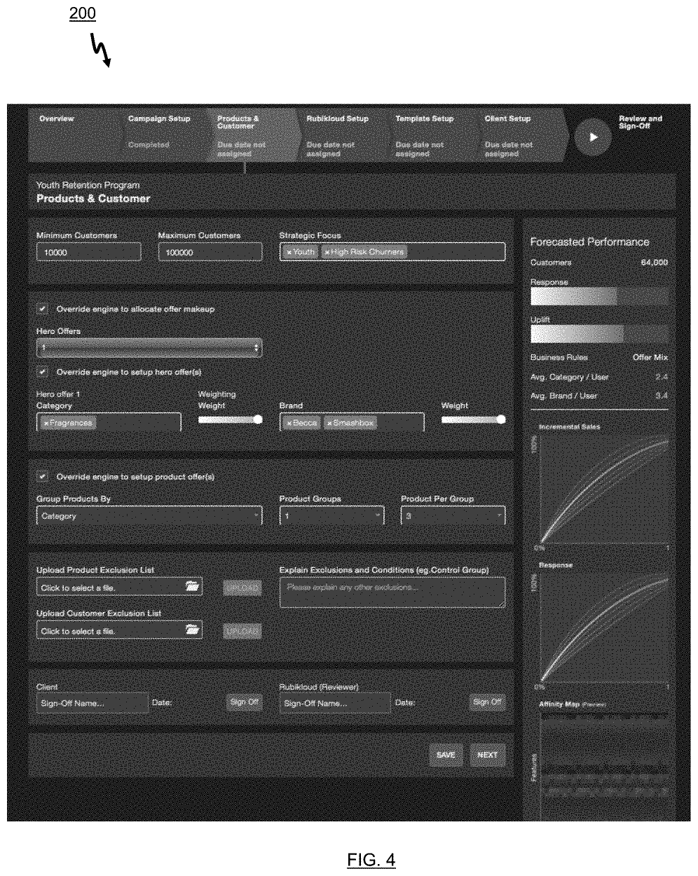

FIG. 4 shows another exemplary campaign definition screen 200 for defining a campaign that enables the following information and attributes to be specified by the attributes module 90:
minimum customers
maximum customers
selection of strategic focus types
an override to specify one or more hero offers to be made, the category and brands of the hero offers, as well as the weighting
a product offering override, the type of product offering, the product groups, and the number of products per group
a product exclusion list
a customer exclusion list
a client approval field
a system manager approval field

In addition, the second campaign definition screen 200 also shows projected results for the campaign in a right panel. The right panel enables the visualization of various elements of the system 20 itself. As a user provides inputs to the attributes module 90 via the input interface 68, such as customer objectives, customer quantities, strategic focus selections, the number and allocation of hero and product offers, the system 20 weighs these different inputs and adjusts the model selection accordingly. As an example, if “win-back” is selected as the primary customer objective, the system 20 tends to over-index the selection of richer offers from the offer and action pool.

Hero offers are offers or content that are relatively generic in nature, such as discounts at a total store or category level (e.g., twice the points when you purchase any skincare product, or 10% off when you purchase anything). Product offers are offers that are narrower in scope (e.g., $1 off of a specific box of cereal, 5% off of a narrow range of a particular brand of lipsticks, etc.).

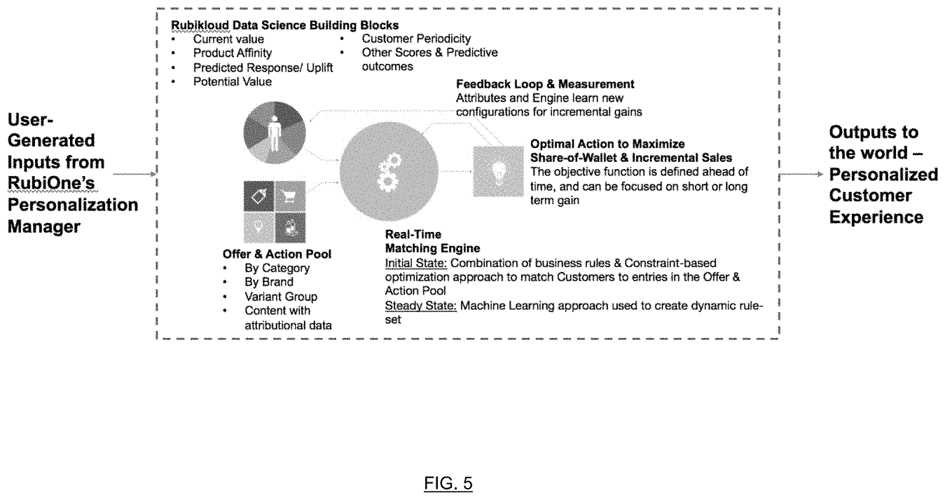

FIG. 5 shows a number of components of the marketing platform. As shown, the system 20 includes the data science module 96 and the selection module 94 (also called a “matching engine”). In addition, a marketing content pool is shown.

The marketing content pool contains a finite collection of marketing content templates that are available to be used via the marketing platform. An example of marketing content could be an offer, such as: spend $80 on skincare products between Jan. 1, 2016 and Jan. 10, 2016 and receive a 25% discount. The attributes in this example can be broken down into their constituent components:
Offer_start_date=Jan. 1, 2016
Offer_end_date=Jan. 10, 2016
Offer_type=%_off
Offer_award=25
Offer_threshold=80
Offer_unit_of measure=Sales
Offer_scope=Skincare

The offer and action pool can also include content or advice. In the grocery space, for example, the offer and action pool can contain recipes. These recipes can be tagged or labeled based on the specific products they use or foods they create. The system 20 can take the recipes and assign them on a one-to-one basis to customers.

The data science module 96 is a set of data mining and machine learning building blocks that generate predictive or explanatory scores about customers. Both supervised and unsupervised learning techniques can be used in generating the scores. These scores are then used by the selection module 94 to match customers to marketing content. The customer data used to generate these scores is a mix of historical point of sale data, other interaction data and various other data sources, and is stored in the customer database 84. The machine learning techniques used to generate these building blocks are specific to the particular building block. For example, a predictive response model can leverage supervised classification techniques. And, by virtue of the specific conditions of what is being predicted, there are naturally various versions of each building block. The purpose of each version is specific to its use case and the context in which it is actually deployed. The engine leverages a standardized naming convention to determine which model version in each building block should be used.

The following are a number of illustrative building blocks used by the data science module 96:

### Predictive Response Model

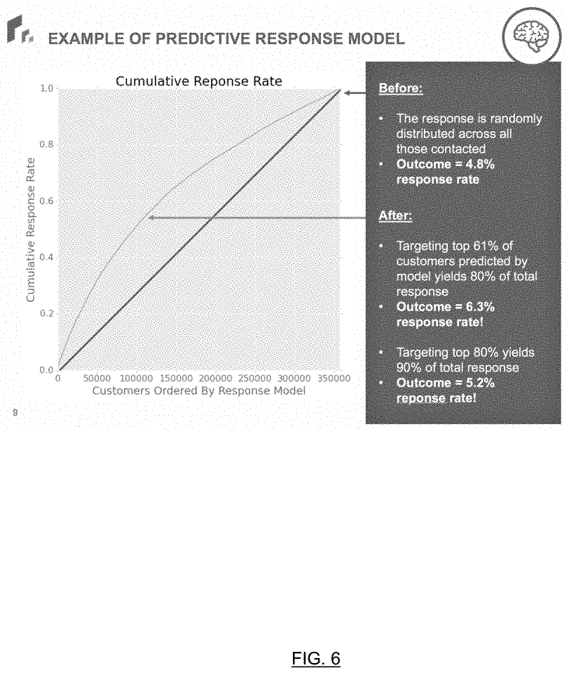

a score between 0 and 1 which can be interpreted as the probability a person may respond to an action
several models are built to account for the conditionality of actions
e.g., P(Action=f(Category, Offertype)) where Category=Fragrance and Offertype=Loyalty Points
FIG. 6 shows a typical approach to visualizing the predictive response model, called a Cumulative Gains Chart or the Receiver Operating Characteristic

### Predictive Uplift Model

similar to the predictive response model, but captures a deeper complexity: the probability a person who will respond to a treatment or action, who in the absence of that treatment or action would not have responded
this type of model speaks directly to the Incremental Sales objective function mentioned below

### Reactive Churn Model

a score capturing a customer's change in value over a particular period of time
a simple implementation of this is computing monetary spend in two adjacent time periods and subtracting them
similarly, when current value segmentation exists (e.g., RFM), comparing the RFM values in two adjacent time periods yields a binary churn classification

### Predictive Churn Model

a predictive variation of the above, computed across various time horizons

### Product Recommender

classifying a customer's affinity to certain products, or product categories

The selection module 94 determines the best mode of achieving the goals of the marketing campaign specified via the campaign editor. In particular, the selection module 94 takes the inputs and constraints received via the campaign editor, the outputted scores for the building blocks in the data science module 96, and the possible marketing content in the marketing content pool, and combines them to generate an output list of what a customer should receive. The various building blocks are assigned weightings and combined with each other to map to specific marketing content. For example, if “win-back” is the highest priority customer objective, a customer's churn score is weighted heavily and heavy negative weightings map very often to marketing content in the marketing content pool with higher incentives.

The selection module 94 is instantiated for each brand new set of data it receives. Prior customer data can be imported into the system to enable the system 20 to benefit from prior experience. In addition, inputs provided impact the assigned weightings of the building blocks of the data science module 96. This instantiation step is a mix of constrained optimization and conditional rules. The reason the system 20 is instantiated is because it doesn't have a base of decisions from which to learn what maximizes the objectives. There needs to be a base of matches for the reinforcement learning capability to have enough data to actually learn.

Beyond instantiation, the steady state of the marketing platform shifts over to a reinforcement learning hybrid approach. As further customer data, in the form of feedback data, is collected by the feedback module 92, the building blocks are re-trained and re-scored by the data science module 96, and, as a result, new predictions are made for customers by the selection module 94.

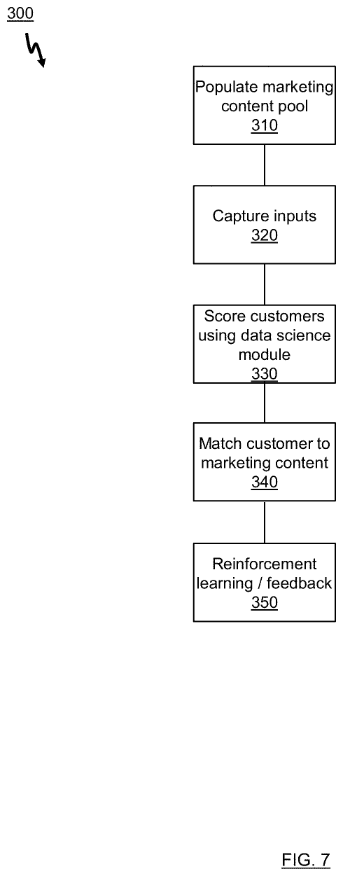

The example below illustrates a particular use case for an example data set and will be discussed with reference to the general method 300 of FIG. 7 used by the system 20 for determining optimized customer touchpoints. At block 310, the marketing content pool is populated as exemplified as follows:

| | | | | | Offer |
|---|---|---|---|---|---|
| Offer_Type | Offer_Award | Offer_threshold | Offer_unit_of_measure | Offer_Scope | Description |
| Buy X, Get Y | 3 | 2 | Units | Total Store | Buy 2 Get 3 |
| Buy X, Get Y | 3 | 2 | Units | Category 1 | Buy 2 Get 3 |
| | | | | | in Category 1 |
| Buy X, Get Y | 3 | 2 | Units | Category 2 | Buy 2 Get 3 |
| | | | | | in Category 2 |
| Buy X, Get Y | 3 | 2 | Units | Category 3 | Buy 2 Get 3 |
| | | | | | in Category 3 |
| Buy X, Get Y | 3 | 2 | Units | Category 4 | Buy 2 Get 3 |
| | | | | | in Category |
| % Off | 15 | 0.1 | Sales | Total Store | 15% off Total |
| | | | | | Store |
| % Off | 20 | 0.1 | Sales | Total Store | 20% off Total |
| | | | | | Store |
| % Off | 25 | 0.1 | Sales | Total Store | 25% off Total |
| | | | | | Store |
| % Off | 15 | 0.1 | Sales | Category 1 | 15% off |
| | | | | | Category 1 |
| % Off | 20 | 0.1 | Sales | Category 1 | 20% off |
| | | | | | Category 1 |
| % Off | 25 | 0.1 | Sales | Category 1 | 25% off |
| | | | | | Category 1 |
| % Off | 15 | 0.1 | Sales | Category 2 | 15% off |
| | | | | | Category 2 |
| % Off | 20 | 0.1 | Sales | Category 2 | 20% off |
| | | | | | Category 2 |
| % Off | 25 | 0.1 | Sales | Category 2 | 25% off |
| | | | | | Category 2 |
| % Off | 15 | 0.1 | Sales | Category 3 | 15% off |
| | | | | | Category 3 |
| % Off | 20 | 0.1 | Sales | Category 3 | 20% off |
| | | | | | Category 3 |
| % Off | 25 | 0.1 | Sales | Category 3 | 25% off |
| | | | | | Category 3 |
| % Off | 15 | 0.1 | Sales | Category 4 | 15% off |
| | | | | | Category 4 |
| % Off | 20 | 0.1 | Sales | Category 4 | 20% off |
| | | | | | Category 4 |
| % Off | 25 | 0.1 | Sales | Category 4 | 25% off |
| | | | | | Category 4 |

At 320, the following received user inputs/constraints are captured as exemplified as follows:
# of customers=200 k
channel=email
start date=Jan. 1, 2015
end date=Jan. 10, 2016
category focus=category 3 activation
long term behavior focus=win-back
other constraints=exclude highest value customers

At block 330, customers are then scored using the data science module 96. In one particular embodiment, this is performed as follows:
Step 1: Exclude highest value customers; this is an illustrative business-specific decision
Step 2: Score customers using the response and uplift models trained on previous scenarios with similar parameters
Step 3: Score customers using reactive and predictive churn models—identify those that must be won-back; churn scores greater than zero are labeled “grow”, those around zero are labeled “retention”, and those less than zero are labeled “win-back”; the magnitude of each score is then used to map customers to one or more offers and/or other types of marketing content in the marketing content pool, depending on threshold parameters set
Step 4: Score customers' affinity to category based on a product affinity matrix; collaborative filtering techniques are used to predict a customer's likelihood of liking a particular product or set of products in a product category
Step 5: Apply equal weighting to scores from Steps 2 through 4 in order to select customers and allocate the marketing content from the marketing content pool, at block 340; e.g., customers with high response and uplift, and high reactive and proactive churn receive highest Offer_Award in Category 4

At block 350, the system 20 then performs reinforcement learning and feedback. Once instantiated, the system 20 can be invoked repeatedly to generate personalized touchpoints for customers. As this process continues, various iterations occur whereby customers are contacted, marketing content is deployed, actions are taken and behavioral data captured by the feedback module 92. The initial weighting system in the instantiation process begins to give way to a machine intelligent approach to matching. The machine learning technique used prioritizes online learning in an environment whose outcomes can be considered as being partly due to randomness and partly due to phenomena under the control of a decision maker. For example, while personalized, lucrative offers to perform a certain action have undoubted causal relationship to the action, there are other random factors which may have contributed to that action.

In an embodiment, the reinforcement learning framework operates as follows: each customer-to-offer match the machine creates that leads to a positive action (defined by positive incremental sales above a certain threshold) is rewarded a +1 whereas each match that leads to a negative action (incremental below a certain threshold) is penalized by −1. This reward structure then impacts the instantiated rules by scaling them up or down. In the example above, if a particular threshold offer was recommended to a customer and that offer was not redeemed, that selection gets penalized and another threshold is tried the next time. This is repeated until the threshold that maximizes the objective (activation) is achieved and rewarded.

The reinforcement learning agent can be expressed as a policy π(mₜ₊₁|{mₜ, oₜ, rₜ}) where mᵢ is the match (e.g., the offer presented to a customer) performed to customer i at time t, oᵢ is the observation based on that match and rᵢ is the reward the agent receives for performing that match. So, in the formulaic expression, the policy is defined as selection of a match at time t+1, given the entire history of matches, observations and rewards up to time t. Thus, a single customer's interaction history at time t can be expressed as hₜ^{C=1}={mᵢ, rᵢ, mᵢ₊₁, rᵢ₊₁, . . . mₜ, oₜ, rₜ}_{C=1} where C=1 denotes customer 1. As each customer has their own interaction history, if there are N customers, there are N interaction histories. The policy described takes not only a single customer's interaction history to determine the optimal match to perform, but rather the entire set of interaction histories. Furthermore, the policy is selected in a greedy way, such that it selects the match which maximizes the observation.

In embodiments, the components of the system are stored by and executed on a single computer system. In other embodiments, the components of the system 20 are distributed among two or more computer systems that may be locally or globally distributed.

The system can be seeded with historical data from which inferences can be drawn, enabling reinforcement learning to be employed using the historical data prior to the collection of further customer data by the system. That is, where previous interactions or touchpoints between the client and their customer base exist and that data is readily available and interpretable, the instantiation phase can be skipped entirely in favor of implementing the reinforcement learning embodiment.

Incremental sales generated by a particular match are not the only observations that can generate a reward. An example of an alternative reward-generating observation is a change in the customer's reactive churn score, or simply the redemption/usage of the offer sent. Thus, the reinforcement learning embodiment is built in such a way as enable various definitions of both observations and rewards.

The system can be instantiated in accordance with the client or user needs. For example, requisite data to generate all the building blocks may not exist, or there may be a set of customers that the client wishes to exclude from contacting, or a set of products that the customer wishes never to promote. Such case-by-case situations can be dealt with when the instantiated matching rules are generated.

The system 20 can change or re-train the models with which the scores themselves are being calculated.

The system 20 can perform reinforcement learning “concurrently” with the receiving of customer data via various channels, enabling the system 20 to continue to match customers to marketing content and learn new weightings.

The reward structure (+1 for good actions, −1 for bad actions) used by the system 20 for reinforcement learning is not the only way it can learn to optimize its operation. The system 20 can alternatively include a weighted reward that is a function of the metric the system 20 is trying to maximize. That is, the system can over-reward for making good decisions but reduce the punishment for bad decisions.

Turning to FIG. 3, a flowchart illustrating a method 400 for determining optimized customer touchpoints, according to embodiments described herein, is shown. At block 410, attributes are assigned for a set of marketing content for a set of customers. At block 420, at least one initial score for the behavior of each of the customers in the set of customers is generated using machine learning techniques based on the attributes. At block 430, a first subset of the marketing content is selected for each of a first subset of the customers to receive for a first marketing campaign based at least partially on the at least one initial score. At block 440, feedback data is received relating to the first subset of the marketing content. At block 450, at least one adjusted score is selected from the at least one initial score for at least some of the customers using reinforcement learning on the feedback data. At block 460, a second subset of the marketing content is selected for each of a second subset of the customers to receive for a second marketing campaign based at least partially on the at least one adjusted score.

While in most cases, the reinforcement learning agent is set to select the greediest action that maximizes the observation value (e.g., incremental sales, customer lifetime value, etc.), it can similarly be set to select another action with a slightly lower reward value based on other competing parameters.

The reinforcement learning agent can update its base of interaction histories in real-time.

The listed data science building blocks are a subset of the full set of all data science building blocks that can be used. Data science building blocks may be added, removed or under-weighted at any time based on user requests or other issues arising from the operation of the engine.

While, in most cases, it is assumed that a customer's behavior is not impacted by interaction with other customers (i.e., customer behavior is identically distributed and conditionally independent), other modes of the system 20 can be employed where this is not necessarily true.

Although the reinforcement learning element of the system 20 makes no assumptions about the “latent” state of a customer, in that the agent itself assumes that all knowledge about a customer is contained within the set of interaction histories, those interactions are composed of matches based on the data science building blocks. Some of these building blocks do, however, model aspects of a customer that are latent (such as their wants and needs for particular goods or services). For example, the product affinity model tries to infer latent features of a customer based on the products they and other customers purchase.

With enough interaction history, the system 20 operating using the reinforcement learning embodiment post-instantiation can be considered an artificially intelligent agent.

The space of inputs can be changed and customized depending on the particular use case. For example, a retailer may want inputs to allow controls on the number of offers and the product categories to focus on, whereas a financial services firm may choose to allow controls on the term or length of contractual or securitized loan agreements.

The system permits the real-time adjustments of the scores using real-time customer data received. Further, the real-time adjustments can be used to adjust the selection of customers to which marketing content is selected, as well as the marketing content made to each customer, in real time.

The system 20 can be thought of as being channel-agnostic. In this sense, as new channels are deployed, the system 20 can accommodate these new channels immediately.

The front-end tool is not necessary for the capture of inputs. Inputs can be provided through alternate modes, such as flat files, etc.

Similarly, inputs can be automated in the form of “triggers”. For example, when a customer performs an action (e.g., visits a website, engages with an in-store associate equipped with a smart device, etc.), preset inputs can be used to generate a touchpoint for the customer.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for determining optimized customer touchpoints on a computer system, the method comprising:
assigning attributes to a set of marketing content for a set of customers;
generating at least one initial score for the behavior of each of the customers in the set of customers using machine learning techniques based on the attributes;
selecting a first subset of the marketing content for each of a first subset of the customers to receive based at least partially on the at least one initial score;
receiving feedback data relating to the first subset of the marketing content;
determining at least one adjusted score, from the at least one initial score, for at least some of the customers, using reinforcement learning on the feedback data; and
selecting a second subset of the marketing content for each of a second subset of the customers to receive based at least partially on the at least one adjusted score.

2. The method of claim 1, wherein the feedback data comprises customer behavioral data of at least a portion of the customers in the first subset of the customers.

3. The method of claim 1, further comprising receiving at least a portion of the attributes from a user.

4. The method of claim 1, wherein the machine learning techniques utilize at least one of:
a predictive response model for determining a probability that a particular customer in the set of customers responds to the marketing content;
a predictive uplift model for determining a probability that a particular customer in the set of customers responds to the marketing content, who in the absence of such marketing content, would not have responded;
a reactive churn model for determining a change in value over a selected period of time for each customer in the set of customers; and
a predictive churn model for determining a change in value over multiple periods of time for each customer in the set of customers.

5. The method of claim 1, wherein the at least one initial score is generated using historical interaction data from the set of customers.

6. The method of claim 1, further comprising assigning weightings to at least a portion of the attributes based on priority of a customer objective.

7. The method of claim 1, wherein the reinforcement learning comprises an incremental reward structure.

8. The method of claim 8, wherein the reward structure is based on increments and decrements in customer sales.

9. The method of claim 1, wherein the reinforcement learning comprises a weighted reward structure.

10. The method of claim 1, wherein receiving the feedback data, determining the at least one adjusted score, and selecting the second subset of the marketing content are performed repeatedly.

11. A system for determining optimized customer touchpoints, the system comprising one or more processors and a data storage device, the one or more processors configured to execute:
an attributes module for assigning attributes to a set of marketing content for a set of customers;
a data science module for generating at least one initial score for the behavior of each of the customers in the set of customers using machine learning techniques based on the attributes;
a selection module for selecting a first subset of the marketing content for each of a first subset of the customers to receive based at least partially on the at least one initial score; and
a feedback module for receiving feedback data relating to the first subset of the marketing content,
the data science module further determines at least one adjusted score, from the at least one initial score, for at least some of the customers, using reinforcement learning on the feedback data, and
the selection module further selects a second subset of the marketing content for each of a second subset of the customers to receive based at least partially on the at least one adjusted score.

12. The system of claim 11, wherein the feedback data comprises customer behavioral data of at least a portion of the customers in the first subset of the customers.

13. The system of claim 11, wherein the attributes module receives at least a portion of the attributes from a user via an input interface.

14. The system of claim 11, wherein the data science module uses machine learning techniques that utilize at least one of:
a predictive response model for determining a probability that a particular customer in the set of customers responds to the marketing content;
a predictive uplift model for determining a probability that a particular customer in the set of customers responds to the marketing content, who in the absence of such marketing content, would not have responded;
a reactive churn model for determining a change in value over a selected period of time for each customer in the set of customers; and
a predictive churn model for determining a change in value over multiple periods of time for each customer in the set of customers.

15. The system of claim 11, wherein the at least one initial score is generated by the data science module using historical interaction data from the set of customers.

16. The system of claim 11, wherein the attributes module assigns weightings to at least a portion of the attributes based on priority of a customer objective.

17. The system of claim 11, wherein the reinforcement learning comprises an incremental reward structure.

18. The system of claim 17, wherein the reward structure is based on increments and decrements in customer sales.

19. The system of claim 11, wherein the reinforcement learning comprises a weighted reward structure.

20. The system of claim 11, wherein the feedback module repeatedly receives new feedback data such that the data science module repeatedly adjusts the at least one adjusted score based on the new feedback data, and the selection module repeatedly selects the second subset of the marketing content based on the new at least one adjusted score.
